(19) United States
(12) Patent Application Publication
(10) Pub. No.: US 2019/0368619 A1
(43) Pub. Date: Dec. 5, 2019

(54) Valve With Hardened Insert

(71) Applicant: Kerr Machine Co., Sulphur, OK (US)

(72) Inventors: Christopher Todd Barnett, Stratford, OK (US); Mark S. Nowell, Ardmore, OK (US); Kelcy Jake Foster, Ardmore, OK (US); Micheal Cole Thomas, Ardmore, OK (US); Michael Eugene May, Ardmore, OK (US)

(21) Appl. No.: 16/512,630

(22) Filed: Jul. 16, 2019

Related U.S. Application Data
(63) Continuation-in-part of application No. 16/169,663, filed on Oct. 24, 2018.
(60) Provisional application No. 62/700,079, filed on Jul. 18, 2018.
(60) Provisional application No. 62/576,443, filed on Oct. 24, 2017.

(51) Int. Cl. F16K 5/02; F16K 1/16; F16K 1/38

(52) U.S. Cl. CPC F16K 5/025; F16K 1/38; F16K 1/16

(57) ABSTRACT

A valve for use in a fluid end. The valve has a solid body with a sealing surface. The valve may move into position where the valve contacts a valve seat. When in contact, the valve and valve seat prevent flow through the valve. The valve and valve seat each have hardened inserts in their respective strike faces. The insert in the valve is less hard than the insert in the valve seat. Both are typically made of a ceramic material, such as tungsten carbide.

### FIELD

The invention is directed generally to valve sealing surfaces for use with pump fluid ends.

### SUMMARY OF THE INVENTION

The invention is directed to a valve assembly. The valve assembly comprises a valve body and a valve seat. The valve seat comprises a curved outer wall, a spaced apart curved inner wall, a strike face and a first insert. The strike face tapers from the outer wall to the inner wall. The first insert is disposed in the strike face of the valve seat and composed of a different material from the strike face of the valve seat. The valve body is characterized by a strike face. The strike face is complementary to the strike face of the valve seat. The valve body comprises a second insert disposed in the strike face of the valve body and composed of a different material than the strike face of the valve body. The first insert and the second insert are characterized by different hardnesses.

In another embodiment the invention is directed to a valve comprising a body and a seat. The body has at least one sealing surface. The sealing surface is characterized by an annular outer section, an annular inner section, and an intermediate metallic portion disposed between the annular outer section and the annular inner section. The annular outer section is at least partially formed from an elastomeric material. The annular inner section is at least partially formed from a carbide material. The seat comprises a strike face and an annular insert. The strike face conforms to a portion of the sealing surface. The annular insert is disposed in the strike face.

### BRIEF DESCRIPTION OF THE DRAWINGS

FIG. 1 is an exploded perspective view of a fluid end.

FIG. 2 is a sectional side view of the fluid end of FIG. 1 along section A-A.

FIG. 3 is a bottom side perspective view of a prior art valve body.

FIG. 4 is a bottom side perspective view of the fluid end valve body of the present invention.

FIG. 5 is a side view of the fluid end valve body of FIG. 4.

FIG. 6 is a cutaway sectional side view of a fluid end bore with the valve body of FIG. 4 disposed therein.

FIG. 7 is a sectional side view of a valve and valve seat.

FIG. 8 is a sectional side view of the valve and valve seat of FIG. 7, with the valve body insert including a convex outer surface.

### DETAILED DESCRIPTION

Fluid end assemblies are typically used in oil and gas operations to deliver highly pressurized corrosive and/or abrasive fluids to piping leading to the wellbore. The assemblies are typically attached to power ends run by engines. The power ends reciprocate plungers within the assemblies to pump fluid throughout the fluid end. Fluid may be pumped through the fluid end at pressures that range from 5,000-15,000 pounds per square inch (psi). Fluid used in high pressure hydraulic fracturing operations is typically pumped through the fluid end at a minimum of 8,000 psi; however, fluid will normally be pumped through the fluid end at pressures around 10,000-15,000 psi during such operations, with spikes up to 22,500 psi.

This increase in maximum pressure causes failures in components not seen at lower pressures. Typical failures now include the failure of valves due to erosion of the valve sealing face which is accelerated by the large closing forces of the valve sealing face against the valve seat. While this failure mode is expected, the higher pressures are decreasing valve life to unacceptable levels. When the valve sealing face fails leakage occurs around the component. Leakage reduces the maximum pressure and flow capabilities of the system.

Efforts to eliminate the erosion of the valve sealing face have included hardening the valve sealing face in the same manner as the valve seat is hardened. The mating hardened surfaces provide an improved seal and allow the system to operate as desired. However, the impact of the hardened valve sealing face against the valve seat increases the erosion rate of both the valve sealing face and the valve seat sealing face due to the closing force associated with the fluid forced in and out of the fluid end by a reciprocating plunger. This failure results in an unacceptably short valve life before repair or replacement of the valve and/or the valve seat is required.

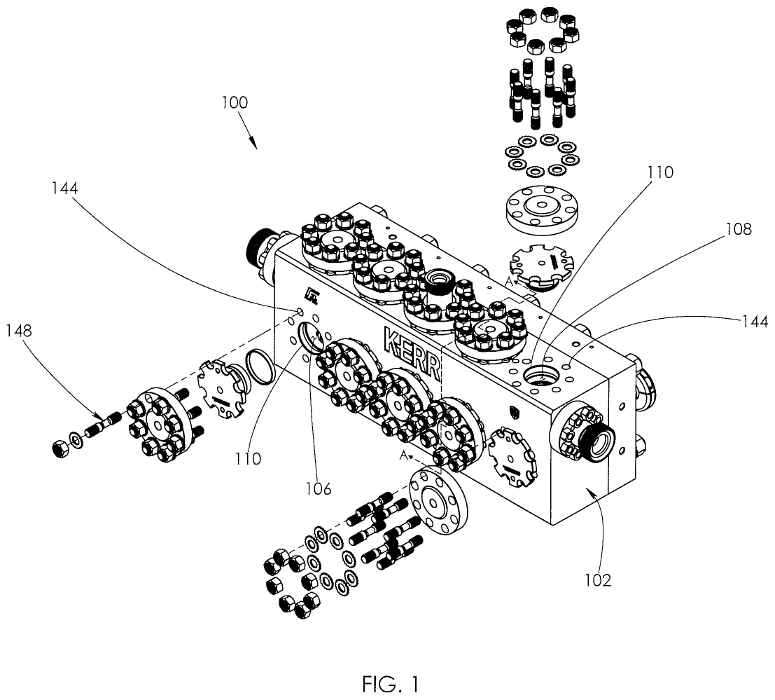

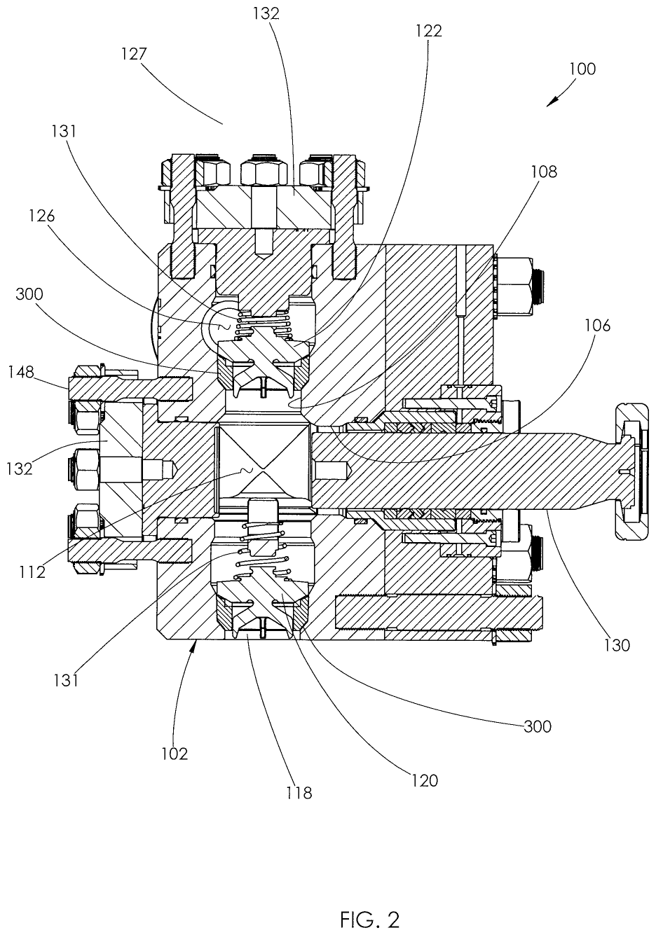

With reference to FIGS. 1 and 2, a fluid end 100 is shown. The fluid end 100 comprises a fluid end body 102 having a plurality of first and second bores 106, 108 formed adjacent one another therein, as shown in FIG. 1. Preferably, the number of first bores 106 equals the number of second bores 108. More preferably, each first bore 106 intersects its paired second bore 108 within the fluid end body 102 to form an internal chamber 112, as shown in FIG. 2.

FIG. 1 shows five first and second bores 106, 108. In alternative embodiments, the number of sets of paired first and second bores in the fluid end body may be greater than five, or less than five.

Each bore of each set of paired bores 106 and 108 terminates in a corresponding opening 110. The bores 106 and 108 and openings 110 exist in one-to-one relationship. A plurality of internally threaded openings 144 may be formed in the body 102 and uniformly spaced around each bore opening 110, as shown in FIG. 1, to accommodate pins 148 and retainers 132 for closing the bore openings 110.

With reference to FIG. 2, each second bore 108 may have an intake opening 118 formed proximate the bottom end of the fluid end body 102. Each intake opening 118 is connected in one-to-one relationship to a corresponding coupler or pipe. These couplers or pipes are fed from a single common piping system (not shown).

A pair of valves 120 and 122 are positioned within each second bore 108. The valves 120, 122 route fluid flow within the body 102. The intake valve 120 blocks fluid backflow through the intake opening 118. The discharge valve 122 regulates fluid through one or more discharge openings 126. A plurality of couplers 127 may be attached to each discharge opening 126 for connection to a piping system (not shown).

Each valve 120, 122 opens and closes due to movement of fluid within the internal chamber 112. A plunger 130 is provided within the first bore 106. As the plunger 130 retracts, the discharge valve 122 closes and the intake valve 120 opens, pulling fluid into the internal chamber 112. As the plunger 130 is advanced into the first bore 106, the intake valve 120 is closed and the discharge valve 122 opens, expelling fluid from the internal chamber 112. As shown in FIG. 2, the discharge valve 122 and intake valve 120 are both closed.

A coil spring 131 is disposed on each valve 120, 122 to center the valve and maintain its placement within the second bore 108. The coil spring 131 may also bias the valves 120, 122 in a closed position. A valve seat 300 is provided with each valve 120, 122 such that repeated impacts occur between the valve and valve seat, rather than the fluid end body 102.

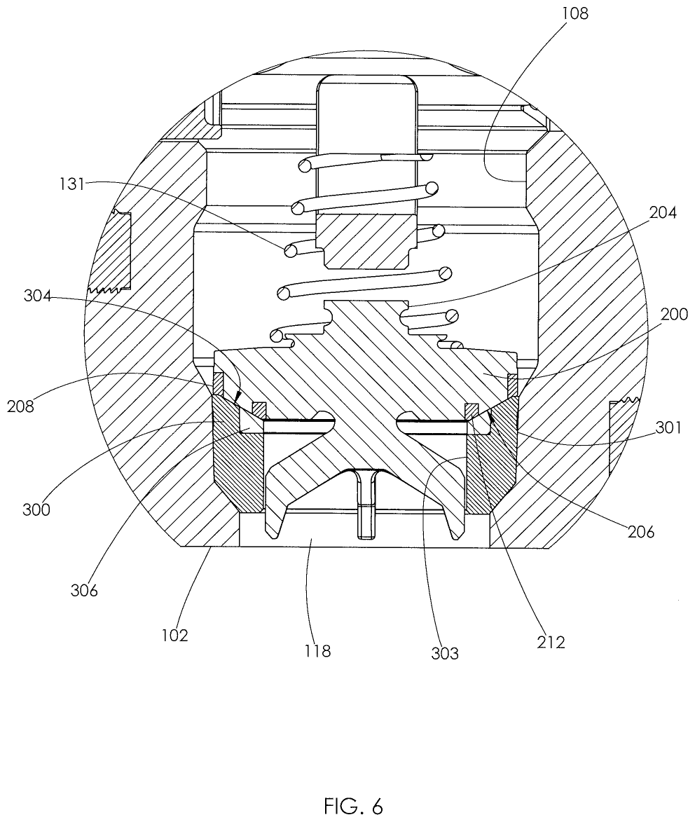

As best shown in FIG. 6, the valve seat 300 is disposed within the second bore 108 and seated against its wall. The valve seat 300 has an outer wall 301 abutting the second bore 108 and an inner wall 303 defining an opening which is coaxial with the bore.

The valve seat 300 comprises a tapered strike face 304 extending from the outer wall 301 to the inner wall 303. The tapered strike face 304 is formed at a non-zero angle relative to the center axis of the bore in which it is situated. The strike face 304 may be hardened, or include a hardened insert 306 to provide durability necessary due to repeated strikes from each valve 120, 122.

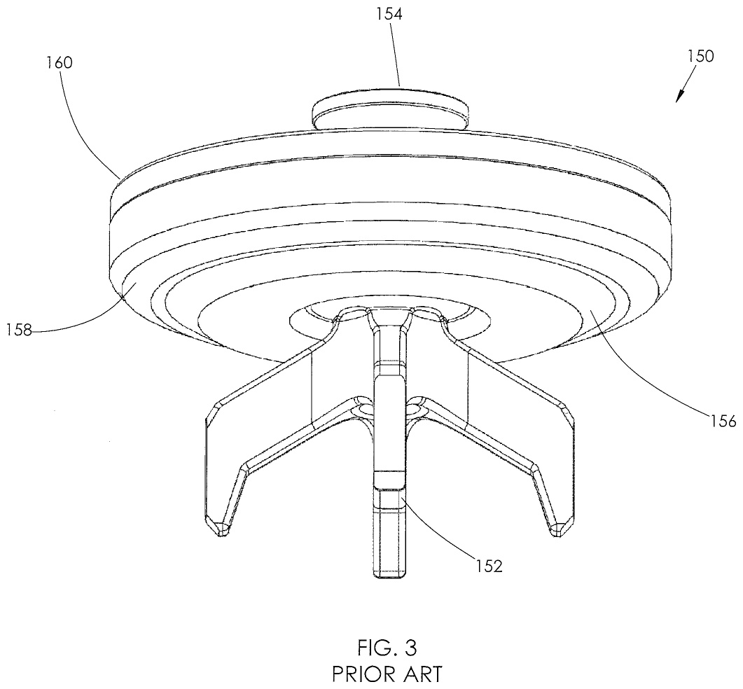

With reference to FIG. 3, a prior art valve 150 is shown. Such a valve 150 may be used as either the intake valve 120 or discharge valve 122.

The valve 150 has a valve body 160 and an alignment structure 152 to assist in maintaining proper valve 150 orientation to the seat 300 (FIG. 2) when in operation and is well known in the art. Protrusion 154 centers the coil spring 131 (FIG. 2). When the valve 150 is closed, a valve sealing surface 156 and valve insert 158 contact the valve seat sealing surface (not shown) stopping fluid flow.

The valve sealing surface 156 is hardened by a post manufacturing process, such as nitriding or flame hardening, or is manufactured from a hard material such as carbide. It is advantageous to have the hardened valve sealing surface 156 to minimize erosion.

Valve insert 158 can be made of any of a number of durable elastomeric materials well known in the art. The elastomeric material may be polyethylene, nitryl rubber, nitrile rubber, or a similar material. Valve insert 158 may be applied to the valve body 160 and may be permanently attached or replaceable. The purpose of valve insert 158 is to provide more sealing capability for the valve 150. While the primary sealing is accomplished by the metal to metal contact of the valve sealing surface 156 to the valve seat 300 sealing surface, it is advantageous to have the elastomeric material encapsulate and seal around any solids trapped between the valve insert 158 and the seat sealing surface.

Once the valve insert 158 deforms, or compresses, the valve sealing surface 156 contacts the seat sealing surface and stops moving. Erosion occurs with each cycle due to the impact of the valve sealing surface 156 on the seat sealing surface.

While the valve insert 158 does contact the seat sealing surface first, it is not designed to reduce the impact force of the valve sealing surface 156 against the seat sealing surface, any reduction of the impact force is incidental. The valve insert 158 instead deforms to provide a backup, or secondary, seal for the valve sealing surface 156. In practice, the elastomeric material used for the valve insert 158 retains the deformation over time and loses the ability to provide any reduction of impact force. This loss of memory causes the valve sealing surface 156 to apply the full force of impact on the seat sealing surface further increasing the erosion rate until the two surfaces erode to the point of valve 150 failure due to the lack of sealing.

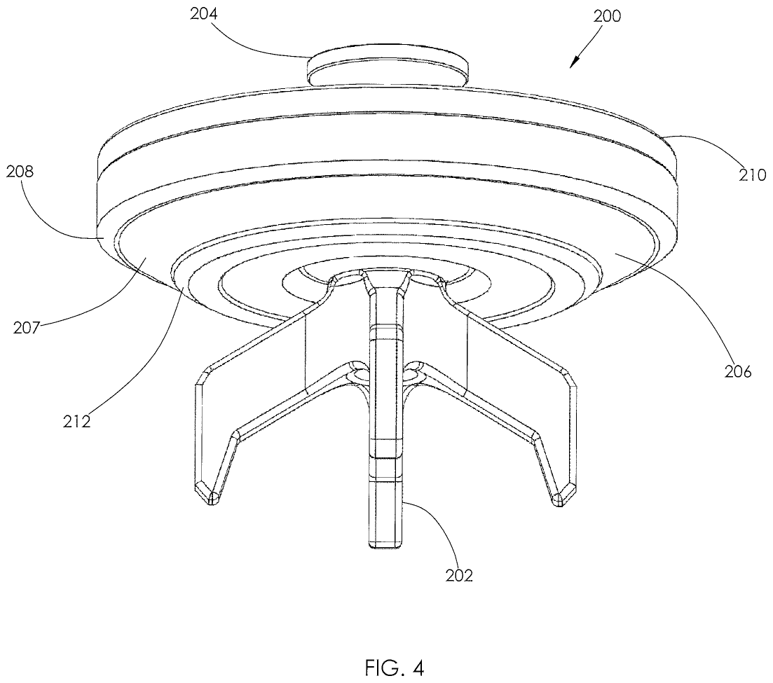

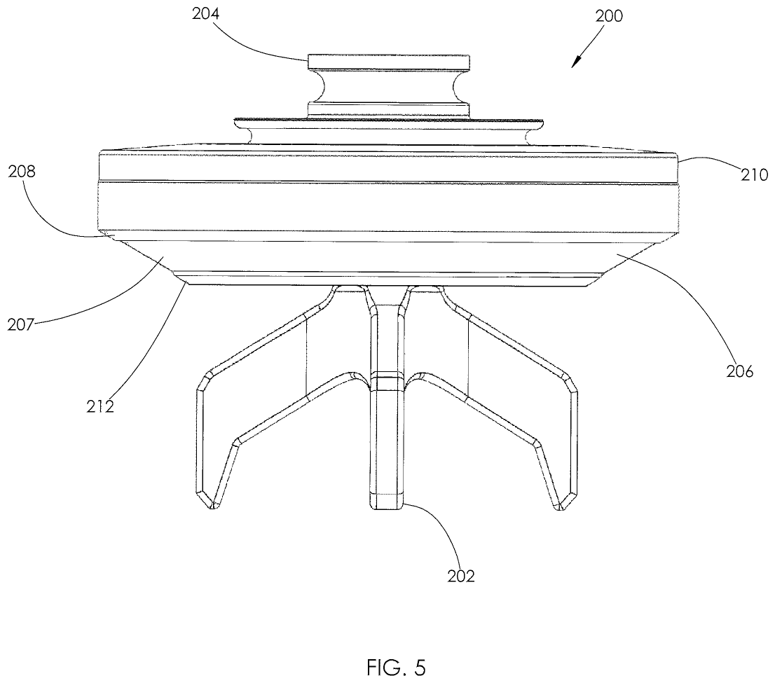

With reference to FIGS. 4-6, an improved valve 200 is shown. The improved valve 200 may be used as either the intake valve 120 or the discharge valve 122.

The valve 200 has alignment structure 202 to assist in maintaining proper valve 200 orientation to the seat 300, when in operation. A protrusion 204 disposed on the valve 200 opposite the alignment structure 202 to provide support for the coil spring 131 (FIG. 2). The valve 200 comprises a valve sealing surface 206 with an outer insert 208 and an inner insert 212 disposed thereon.

When the valve 200 is closed by the spring 131, the valve sealing surface 206, outer valve insert 208, and inner valve insert 212 contact the seat sealing surface 304 stopping fluid flow.

Valve sealing surface 206 may be hardened by a post manufacturing process, such as nitriding or flame hardening, or is manufactured from a hard material such as carbide. It is advantageous to have the hardened valve sealing surface 206 to minimize erosion providing the valve 200 does not fail prematurely. The area of the valve sealing surface 206 is larger than that of typical metal to metal seal valves, such as the previously attempted solution described above. The larger surface area is to reduce the amount of impact force per unit area imparted to the two sealing surfaces. If the closing force is the same and the surface area is increased then the amount of force per unit area is decreased which reduces the amount of erosion caused by the impact force.

The outer valve insert 208 is disposed on the sealing surface 206 along its outer edge, at a transition between the sealing surface 206 and a side wall. Outer valve insert 208 can be made of any of a number of elastomeric materials well known in the art. The specific material is selected based on the sealing qualities of the material in the fluid being controlled. Polyurethane, polyethylene, and rubber compounds may be advantageous. As with valve 150 and insert 158, the outer valve insert 208 provides sealing capability for the valve 200.

While the primary sealing is accomplished by the metal to metal contact of the valve sealing surface 206 to the seat sealing surface 304, it is advantageous to have the elastomeric material encapsulate and seal around any solids trapped between the outer valve insert 208 and the seat sealing surface 304.

The inner valve insert 212 is disposed at an inner and lower extremity of the valve sealing surface 206. The inner valve insert 212 should be placed such that its radius is approximately the inner diameter of the seat sealing surface 304. An exposed portion 207 of the valve sealing surface 206 is disposed intermediate the inner valve insert 212 and the outer valve insert 208. It is this exposed portion 207 that performs the majority of the sealing function for the valve 200.

Inner valve insert 212 can be made of elastomeric materials that are suitable for the fluid being controlled, however the selection is based on energy absorption capacity and memory capability of the material not the sealing qualities. While elastomeric materials may accomplish this, a reinforced elastomer or molded urethane material may be preferable to increase energy absorption and insert 212 life.

The two inserts 208, 212 may be made of the same material if desired. If the same material is used for both inserts 208, 212 the design may be changed to account for the different purpose of each insert. Inner valve insert 212 will reduce the impact force between the valve sealing surface 206 and the seat sealing surface 304. Some sealing may occur at inner valve insert 212 as well, but its primary function is that of a shock absorber.

The sealing surface 206 fully conforms to a portion of an imaginary smooth surface that extends between a pair of parallel planes that respectively limit the upper and lower ends of the valve body. The surface separates interior and exterior regions. The inserts 208 and 212 project within the exterior region while the sealing surface 206 does not project within the exterior region.

As the valve body 210 moves axially toward the seat during valve closure, the inserts 208 and 212 contact the seat sealing surface 304 before the sealing surface 206 does so. Preferably, the axial extent of insert 212 within the exterior region, relative to the sealing face 206, exceeds that of insert 208. The inner insert 212 thus contacts sealing surface 304 during closure of the valve 200 before either the outer insert 208 or valve sealing surface 206.

Any valve that uses one or more hardened surfaces may be improved by reducing the impact force of the valve sealing surface against the seat sealing surface. For instance, the inner valve insert 212 may be made of any material that will absorb enough energy to reduce the impact force to a level that both reduces erosion on the sealing surface 206 to an acceptable rate and deforms or compresses enough to allow the exposed sealing surface 207 to contact the seat sealing surface 304.

Another embodiment may include forming the inner valve insert out of hardened material and placing a spring or any other energy absorbing component between it and the valve body, axially, to absorb the energy and allow the movement necessary to allow the hardened sealing surfaces to contact.

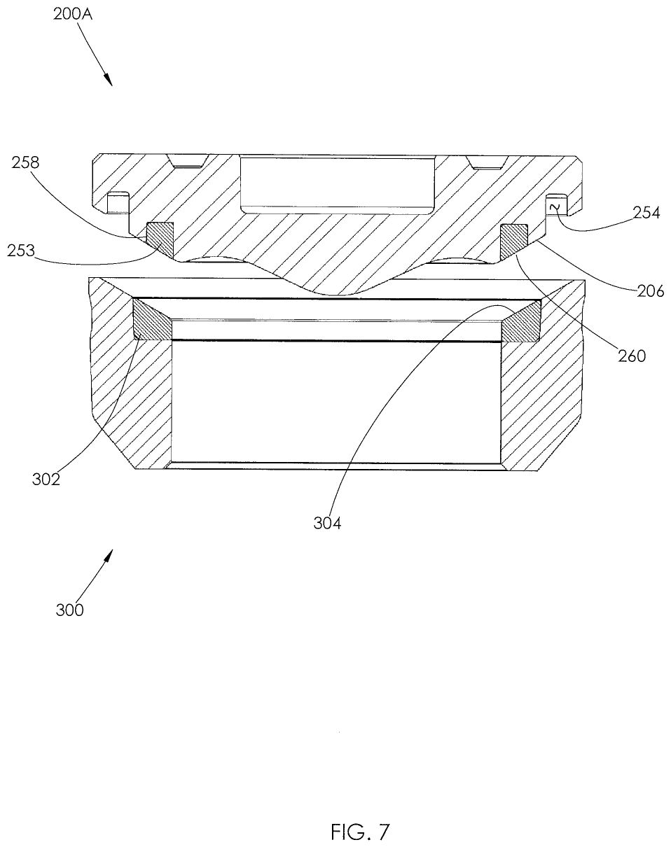

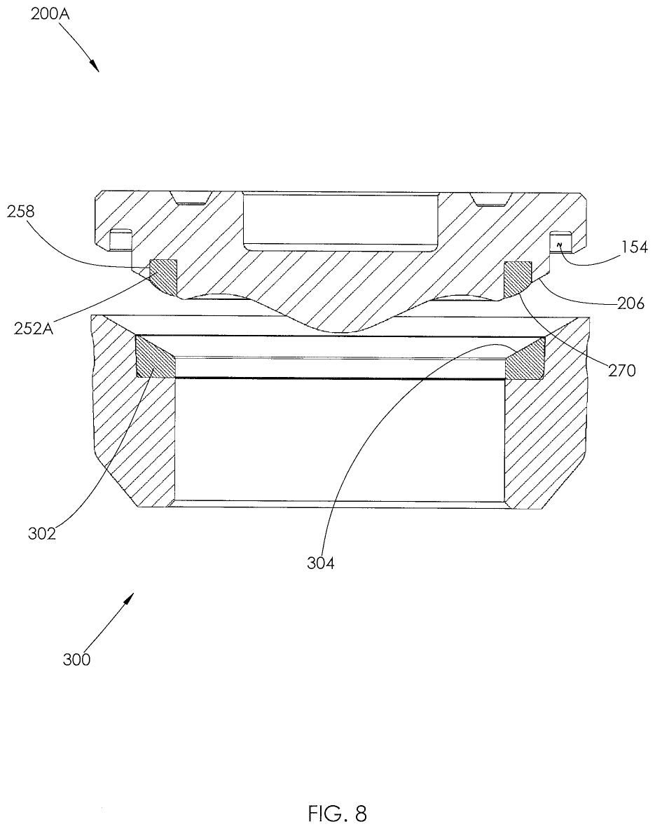

With reference to FIGS. 7-8, a valve 200A is shown with an insert 252 within an insert groove 258 similar to insert 212 in FIGS. 4-6. The valve is configured to seal against seat 300. The groove 258 is on the sealing face 206 of valve 200A.

The valve 200A has a seal groove 254 at its radius on a sealing face 206 of the valve 200A to allow for the insertion and retention of outer insert or seal 208 (FIG. 4). Using a narrower seal 208 and corresponding seal groove 254 provides sufficient space for placement of the insert 252 within the groove 258 without having such a thin wall between the two grooves 254, 258 that premature failure occurs. As shown, groove 258 is an inner groove, having a smaller radius than seal groove 254.

The insert 252 is preferably a carbide material. The insert may be retained by providing an interference fit between the carbide insert groove 258 and the carbide insert 252. Alternatively, connectors, adhesives, splines, and other methods of attachment may be utilized.

The carbide insert 252 has a seal face 260 that is planar and flush with the rest of the valve sealing face 206 when installed. The insert seal face 260 contacts the seal face 304 of the seat insert 302 when the valve 200A is closed. Since both inserts 302, 252 are made of harder material than the sealing surfaces of the valve 200A and seat 300, the erosion rate is reduced and service life increased.

Even though the service life is increased due to the presence of the harder carbide material at the sealing faces 26o, 304, the valve 200A and seat 300 will still eventually erode. It is much more difficult to replace the seat 300 than the valve 200A. As a result, it is preferred that the valve 200A wear more quickly.

To facilitate the selective need for replacement, the insert 252 in the valve 200A is purposefully selected to be softer than the insert 302 of the seat 300. Even with the softer carbide material used for the valve carbide insert 252, both inserts 252, 302 are still much harder than their respective host material and provide a far greater life than previous valve/seat combinations.

Hardness can be edited in carbide products by selecting a carbide with differing binder or cement concentrations. For example, when cobalt is used as a binder in tungsten carbide, its inclusion makes the tungsten carbide softer. In addition, very fine grain tungsten carbides have very high hardness, while coarse grain carbides are less brittle but softer. Thus, insert 302 may be a low cobalt concentration or fine grain tungsten carbide. Insert 252 may be of a higher cobalt concentration, or coarser grain structure, or both.

In order to enhance the life of the softer valve body insert 252, it may be advantageous to use an insert 252A having a convex sealing face 270 as shown in FIG. 8. The convex sealing face 270 provides for the closure of the valve 200A even when wear is uneven or there is misalignment between the two sealing faces 270, 304. As the insert 252 wears, the sealing area between the insert 252A and insert 302 increases.

Alternative configurations are possible. The radial positions of the elastomeric seal and carbide insert 252, 252A could easily be switched with appropriate modifications to the position of the seat insert 302. The inserts 252, 252A, 302 may be made of any material that is harder than the base material of the valve, including other ceramics besides carbide and certain metal alloys. It is also contemplated that the convex face of the insert, as described in FIG. 8, may be shapes other than the curved cross-section of the convex face 270 shown. Any extra material formed on the sealing surface 270 of an insert such as insert 252 could provide sealing in the event of misalignment of the valve 200A and seat 300.

Another embodiment may reverse the positions of the inner and outer inserts making the inner valve insert 212 the sealing insert and the outer insert 208 the energy absorption insert.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A valve assembly comprising:
a valve seat comprising:
a curved outer wall;
a curved inner wall spaced apart from the outer wall;
a strike face tapering from the outer wall to the inner wall; and
a first insert disposed in the strike face of the valve seat and composed of a different material than the strike face of the valve seat;
a valve characterized by a strike face complementary to the strike face of the valve seat, the valve comprising:
a second insert disposed in the strike face of the valve and composed of a different material than the strike face of the valve; and
wherein the first insert and second insert are characterized by different hardnesses.

2. The valve assembly of claim 1 in which the second insert is harder than the first insert.

3. The valve assembly of claim 1 in which the second insert is made of a carbide material.

4. The valve assembly of claim 1 in which the strike face of the valve is congruent to the curved surface of a conical frustum.

5. The valve assembly of claim 4 in which the second insert has a convex surface which does not conform to the curved surface of a conical frustum.

6. The valve assembly of claim 1, defining an imaginary smooth surface in which the smooth surface:
extends axially between parallel planes limiting the upper and lower ends of the valve;
fully conforms to the strike face of the valve; and
separates exterior and interior regions;
wherein the second insert projects within the exterior region and the strike face does not project within that region.

7. The valve assembly of claim 6 in which the imaginary smooth surface is a conical frustum.

8. The valve assembly of claim 1 further comprising:
a third insert disposed within the strike face of the valve, the third insert having an internal diameter larger than an external diameter of the second insert.

9. The valve assembly of claim 8 in which the third insert is elastomeric.

10. The valve assembly of claim 9 in which the first insert and second insert are each made of a ceramic material.

11. A fluid end comprising:
a unitary body having a first bore and a second bore, wherein the first bore and the second bore intersect at an internal chamber;
a fluid inlet in communication with the second bore;
a fluid discharge in communication with the second bore;
an intake valve comprising the valve assembly of claim 1, disposed in the second bore between the fluid inlet and the internal chamber; and
a discharge valve comprising the valve assembly of claim 1, disposed in the second bore between the fluid discharge and the internal chamber.

12. The fluid end of claim 11 further comprising a plunger disposed within the first bore.

13. A valve comprising:
a body having at least one sealing surface characterized by:
an annular outer section at least partially formed from an elastomeric material;
an annular inner section at least partially formed from a carbide material; and
an intermediate metallic portion disposed between the annular outer section and the annular inner section; and
a seat comprising:
a strike face conforming to a portion of the sealing surface; and
an annular insert disposed in the strike face.

14. The valve of claim 13 wherein the annular insert in the seat is formed of a carbide material.

15. The valve of claim 14 in which the carbide material in the annular insert in the seat is harder than the carbide material in the annular inner section of the body.

16. The valve of claim 13 defining an imaginary smooth surface in which the smooth surface:
extends axially between parallel planes limiting the upper and lower ends of the body;
fully conforms to the intermediate metallic portion; and
separates exterior and interior regions;
wherein the annular inner section projects within the exterior region and the intermediate metallic portion does not project within that region.

17. The valve of claim 13 in which the body is movable from a first position to a second position relative to the seat, in which the first position is characterized by the sealing surface contacting and being in sealing engagement with the strike face of the seat.

18. A fluid end comprising:
a body having a bore disposed therein; and
the valve of claim 17 disposed within the bore such that the seat is fixed in position within the bore.
